(19) United States
(12) Patent Application Publication
(10) Pub. No.: US 2025/0019941 A1
(43) Pub. Date: Jan. 16, 2025

(54) WATER SUPPLY SYSTEM CAPABLE OF DETECTING FAUCET MALFUNCTION USING WATER FLOW RATE

(71) Applicant: Hsiang-Hung Wang, Changhua County (TW)

(72) Inventors: Hsiang-Hung Wang, Changhua County (TW); Yu-Chang Lin, Changhua County (TW)

(21) Appl. No.: 18/351,501

(22) Filed: Jul. 13, 2023

(51) Int. Cl. E03B 7/00; E03B 7/07; E03C 1/05; G06Q 10/20; G06Q 50/06

(52) U.S. Cl. CPC E03B 7/003; E03B 7/072; E03C 1/057; G06Q 10/20; G06Q 50/06; E03C 2001/026

(57) ABSTRACT

The water supply system utilizes a water flow rate sensor to monitor the water flow status of a sensor faucet and analyze whether any malfunction is present. In the event of a malfunction, the system utilizes a telecommunications network to transmit the fault message, enabling management personnel to identify the specific sensor faucet that is faulty, determine the cause of the malfunction, and contact maintenance personnel for repairs in the water supply system.

### BACKGROUND OF THE INVENTION

### (a) Technical Field of the Invention

The present invention is generally related to water supply systems, and more particular to a water supply system capable of detecting faucet malfunction using water flow rate.

### (b) Description of the Prior Art

In large public places such as train stations and airports, most restrooms use sensor faucets. Due to their touchless design, sensor faucets reduce the chances of people coming into contact with the faucets while serving purposes such as handwashing and cleanliness.

However, most sensor faucets are unable to respond promptly when they malfunction, resulting in significant water wastage. Additionally, sensor faucets have a more complex structure, requiring maintenance personnel to not only remove the faucet body but also identify which specific component is faulty.

Furthermore, when sensor faucets malfunction, the management personnel need to search for qualified technicians for repairs. However, sensor faucets are intricate and often come with product warranties. If non-original repair personnel are sought, not only can it result in the manufacturer refusing warranty coverage, but there is also a higher risk of the repair technician not knowing which specific component is faulty, potentially causing permanent damage to the sensor faucet.

### SUMMARY OF THE INVENTION

A major objective of the present invention is to provide a water supply system utilizing a water flow rate sensor to monitor the water flow status of a sensor faucet and analyze whether any malfunction is present. In the event of a malfunction, the system utilizes a telecommunications network to transmit the fault message, enabling management personnel to identify the specific sensor faucet that is faulty, determine the cause of the malfunction, and contact maintenance personnel for repairs in the water supply system.

The water supply system includes a sensor faucet, a water flow rate sensor, and a processing unit.

The sensor faucet includes an infrared sensor, an electromagnetic valve for turning on or shutting off water supply, and a fault indication unit.

The water flow rate sensor is configured between the electromagnetic valve and a water outlet of the sensor faucet to detect a water flow rate and a water flow duration of the sensor faucet.

The processing unit is electrically connected to the electromagnetic valve. Data of the water flow rate and the water flow duration are transmitted by the water flow rate sensor to the processing unit for analysis. When the water flow rate is normal and the electromagnetic valve operates properly, the processing unit determines that the sensor faucet is functioning correctly. If the water flow rate does not meet a set value or the water flow duration exceeds a preset time, and the infrared sensor of the sensor faucet detects activity but no water is discharged, the processing unit determines that the sensor faucet is faulty. The processing unit generates a signal to the fault indication unit, which generates a fault alert for a management personnel.

The water supply system may further include a wireless transmission device connected to the processing unit. When the processing unit determines that the sensor faucet is faulty, in addition to generating a signal to the fault indication unit, the processing unit also generates a fault message to the management personnel through the wireless transmission device.

The water supply system may further include a cloud server and a background management module data-lined with the cloud server. The wireless transmission device uploads the fault message to the cloud server; and the background management module displays information including a location of the faulty sensor faucet, an identification number of the faulty sensor faucet, and a cause to the faulty sensor faucet.

The background management module may be a smart mobile device.

As described, the water supply system provides the following major advantages.

1. The processing unit utilizes water flow sensing technology to detect the water flow status of the sensor faucet. In this way, it can detect whether the water flow duration is normal, there is abnormal water flow, water should be dispensed but it is not, or there are faults such as continuous water flow even after the user's hands have been removed. These fault conditions are then displayed through the fault indication unit.

2. The present invention further integrates a wireless transmission device to utilize telecommunications networks (such as WiFi or Bluetooth) for transmitting fault information. Management personnel can use smart mobile devices or personal assistants to assist in managing sensor faucets in restrooms. This reduces manpower management costs.

3. When a faucet malfunctions, the background management module can be utilized to locate maintenance personnel or service providers for repairing and maintaining the sensor faucets. This enables quick resolution of the faucet malfunctions, and the repairs are covered under the original manufacturer's warranty.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a water supply system according to an embodiment of the present invention.

FIG. 2 is a schematic diagram showing a water flow rate sensor of the water supply system of FIG. 1.

FIG. 3 is a flow diagram showing that the water supply system determines that a sensor faucet function normally.

FIG. 4 is a flow diagram showing that the water supply system determines that a sensor faucet has a blockage issue.

FIG. 5 is a flow diagram showing that the water supply system determines that a sensor faucet has a leakage issue.

FIG. 6 is a flow diagram showing that the water supply system determines that a sensor faucet has a no-water-flow issue.

FIG. 7 is a flow diagram showing that the water supply system determines that a sensor faucet has a not-closing issue.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

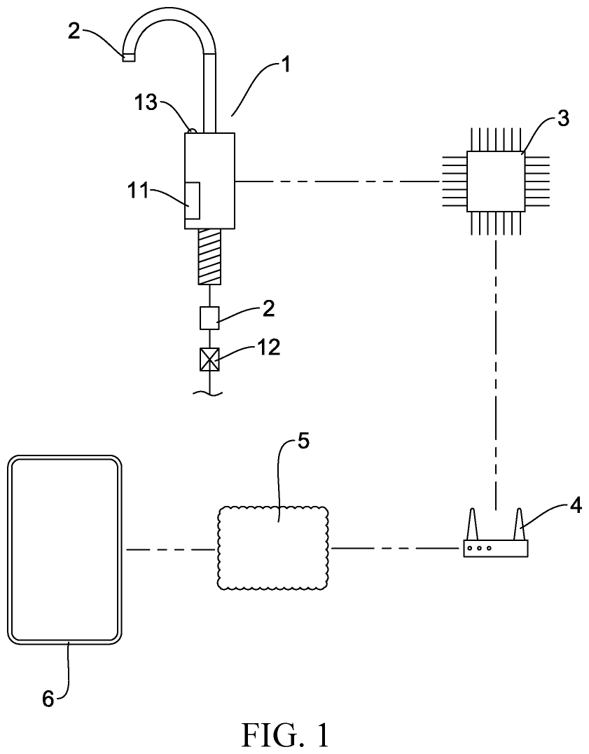

As shown in FIG. 1, a water supply system according to an embodiment of the present invention includes a sensor faucet 1, a water flow rate sensor 2, —processing unit 3, a wireless transmission device 4, a cloud server 5, and a background management module 6.

As shown in FIG. 1, the sensor faucet 1 includes an infrared sensor 11, an electromagnetic valve 12 for turning on or shutting off water supply, and a fault indication unit 13.

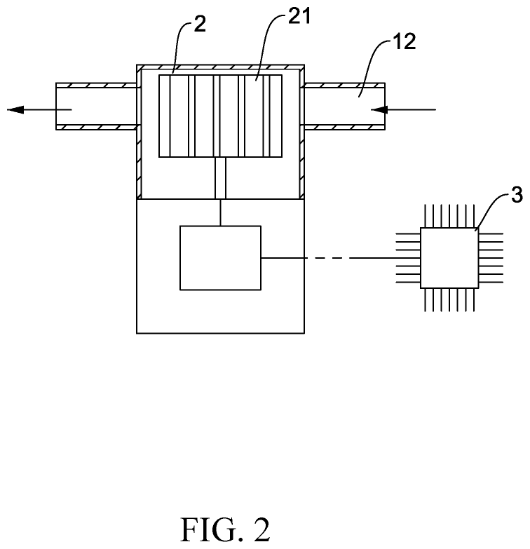

As shown in FIG. 1, The water flow rate sensor 2 is installed between the electromagnetic valve 12 of the sensor faucet 1 and a water outlet of the sensor faucet 1. It is used to detect the water flow rate and water flow duration generated by the sensor faucet 1. It transmits the aforementioned water flow rate and duration data to the processing unit 3 for analysis. As shown in FIG. 2, specifically, the water flow rate is determined based on the number of times a wheel 21 inside the water flow rate sensor 2 is turned by water flowing through the water flow rate sensor 2. However, this is just one of the ways of how the water flow rate sensor 2 operates. The water flow rate sensor 2 is not limited to this method.

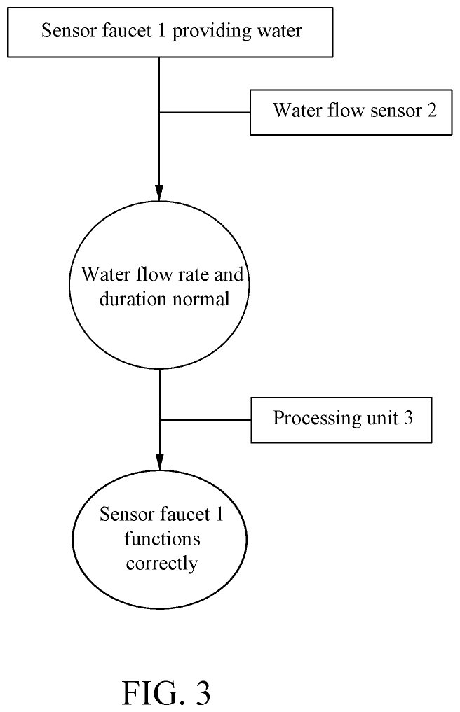

As shown in FIGS. 3 to 7, The processing unit 3 analyzes the data transmitted by the water flow rate sensor 2 and is electrically connected to the electromagnetic valve 12 inside the sensor faucet 1. When the water flow rate is normal and the electromagnetic valve 12 operates properly, the processing unit 3 determines that the sensor faucet 1 is functioning correctly. If the water flow rate does not meet the set value or the water flow duration exceeds the preset time, and the infrared sensor 11 of the sensor faucet 1 detects activity but no water is discharged, the processing unit 3 determines that the sensor faucet 1 is faulty. The processing unit 3 generates a signal to the fault indication unit 13, which then generates a fault alert for the management personnel.

As shown in FIG. 1, when the processing unit 3 determines that the sensor faucet 1 is faulty, in addition to generating a signal to the fault indication unit 13, it also generates a fault message to the management personnel through the wireless transmission device 4.

As shown in FIG. 1, As shown in FIG. 1, the wireless transmission device 4 uploads the fault message to a cloud server 5. The cloud server 5 is connected to a background management module 6, which is used to display information including the location of the sensor faucet 1 that generated the fault, the identification number of the sensor faucet 1, and the cause of the sensor faucet 1's malfunction.

In the present embodiment, the background management module 6 is a smart mobile device or a personal mobile assistant device, allowing management personnel to remotely obtain the status of sensor faucet 1. This helps in reducing manpower management cost.

The advantages of the present invention are as follows.

1. The sensor faucet 1 can be set with different water flow durations of user handwashing. The processing unit 3, through its connection with the electromagnetic valve 12, can verify whether the electromagnetic valve 12 is properly turned on or shut off. Additionally, the water flow rate sensor 2 is utilized to obtain information about the water flow rate and check if the water flow duration is normal.

2. The aforementioned water flow rate can be used to determine if there is any blockage in the water flow, or if there is any leakage, or if the water is flowing properly.

3. As shown FIG. 3, when the water flow rate matches the set value for water discharge, the infrared sensor 11 detects that the user has finished handwashing, the electromagnetic valve 12 is closed, and no water flows out, it is determined that the sensor faucet 1 is operating normally. In this case, the processing unit 3 remains inactive.

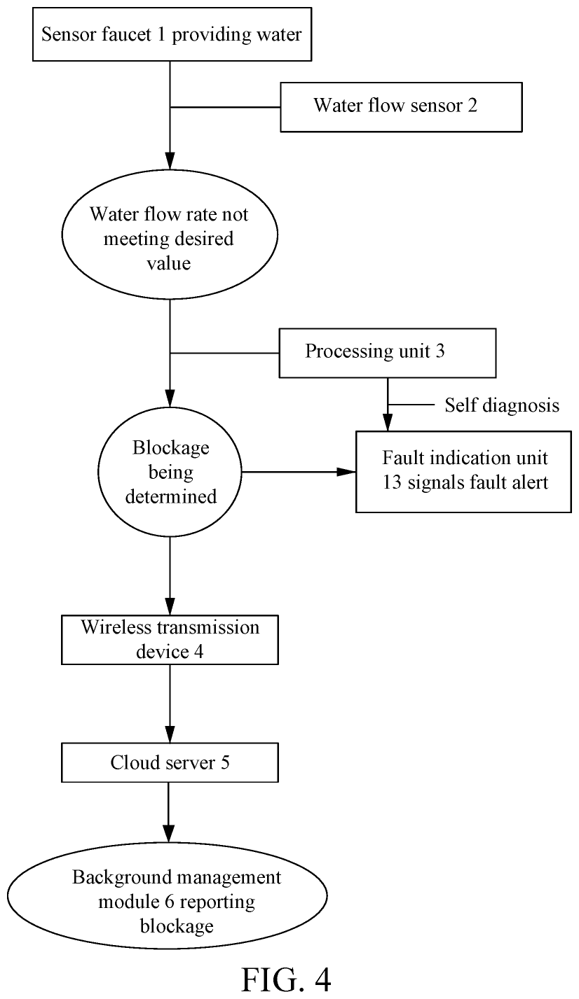

4. As shown in FIG. 4, when the water flow rate does not meet the desired value, for example, when it is supposed to flow at a rate of 1 liter per minute but the water flow rate sensor 2 detects a rate of only 0.3 liters per minute, the processing unit 3 determines that there may be a blockage or other malfunction in the sensor faucet 1. The processing unit 3 identifies the sensor faucet 1 as faulty and signals a fault alert through the fault indication unit 13. Furthermore, the wireless transmission device 4 uploads the fault message to the cloud server 5. The cloud server 5 sends the location of the faulty sensor faucet 1 and information regarding the blockage issue to the background management module 6. The management personnel can then remotely manage the sensor faucet 1.

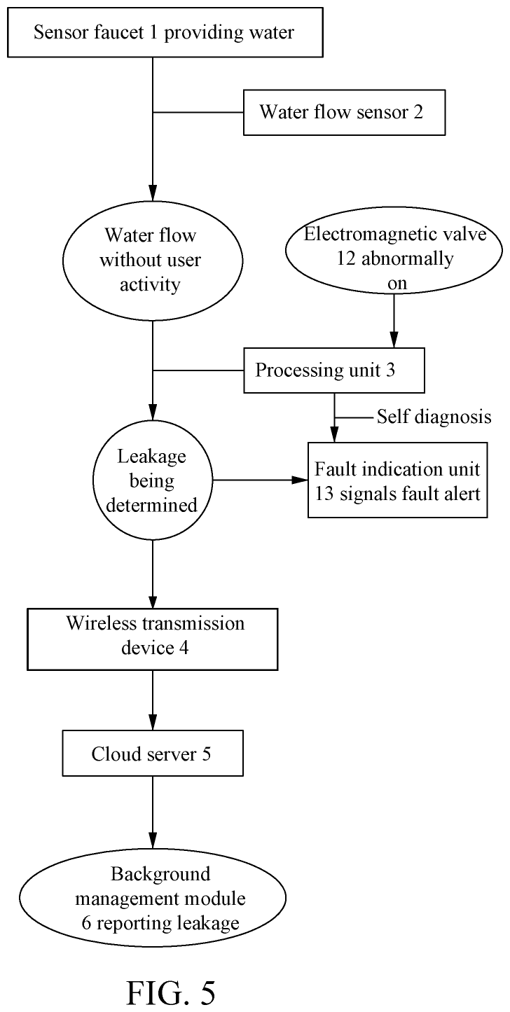

5. As shown in FIG. 5, when the infrared sensor 11 of the sensor faucet 1 does not detect any user activity, but the processing unit 3 detects water flow and measures the water flow duration based on the water flow rate sensor 2 readings, and the electromagnetic valve 12 is open in this case, the processing unit 3 determines that there is a leakage in the sensor faucet 1. It signals a fault alert through the fault indication unit 13. Additionally, the wireless transmission device 4 uploads the fault message to the cloud server 5. The cloud server 5 sends the location of the faulty sensor faucet 1 and information regarding the leakage with the electromagnetic valve 12 to the background management module 6. To prevent potential misjudgments by the processing unit 3, a self-diagnostic process is included. When the situation depicted in FIG. 4 occurs, the processing unit 3 connects to the infrared sensor 11 of the sensor faucet 1 and reduces the sensing distance of the infrared sensor 11. When the infrared sensor 11 reaches its minimum sensing distance, the processing unit 3 confirms that there is indeed a fault with the electromagnetic valve 12 and uploads the fault message to the background management module 6 to notify the management personnel for repairs.

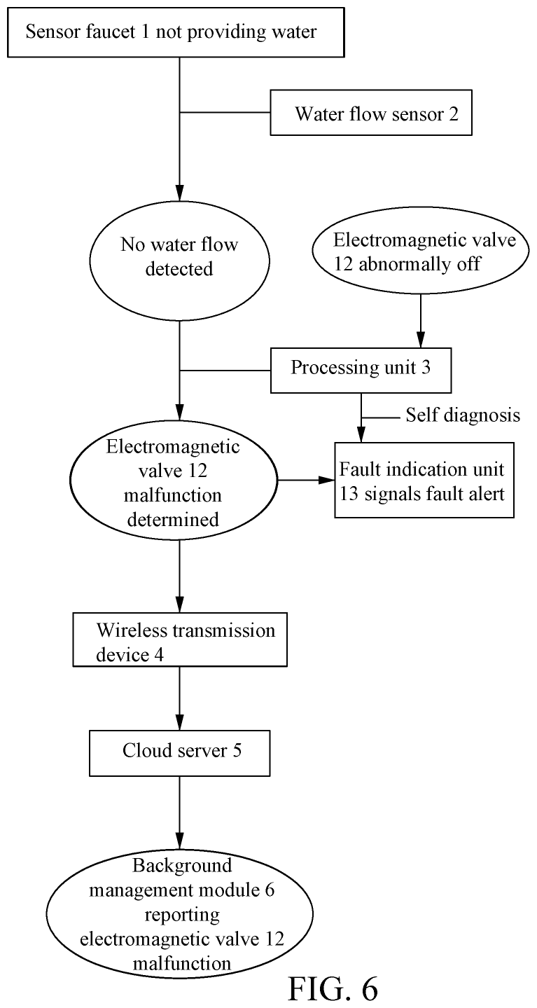

6. As shown in FIG. 6, when the infrared sensor 11 of the sensor faucet 1 detects user activity, but the processing unit 3 does not detect any water flow or water flow duration based on the water flow rate sensor 2 readings, and the electromagnetic valve 12 is not open in this case, the processing unit 3 determines that there is a malfunction in the sensor faucet 1 causing no water flow. It signals a fault alert through the fault indication unit 13. Additionally, the wireless transmission device 4 uploads the fault message to the cloud server 5. The cloud server 5 sends the location of the faulty sensor faucet 1 and information regarding the issue of the electromagnetic valve 12 not producing water flow to the background management module 6. To prevent potential misjudgments by the processing unit 3, a self-diagnostic process is included. When the situation depicted in FIG. 5 occurs, the processing unit connects to the electromagnetic valve 12 of the sensor faucet 1 and generates a signal to open the electromagnetic valve 12. If multiple attempts to open the electromagnetic valve 12 result in no water flow detected, the processing unit 3 confirms that there is indeed a fault with the electromagnetic valve 12 and uploads the fault message to the background management module 6 to notify the management personnel for repairs.

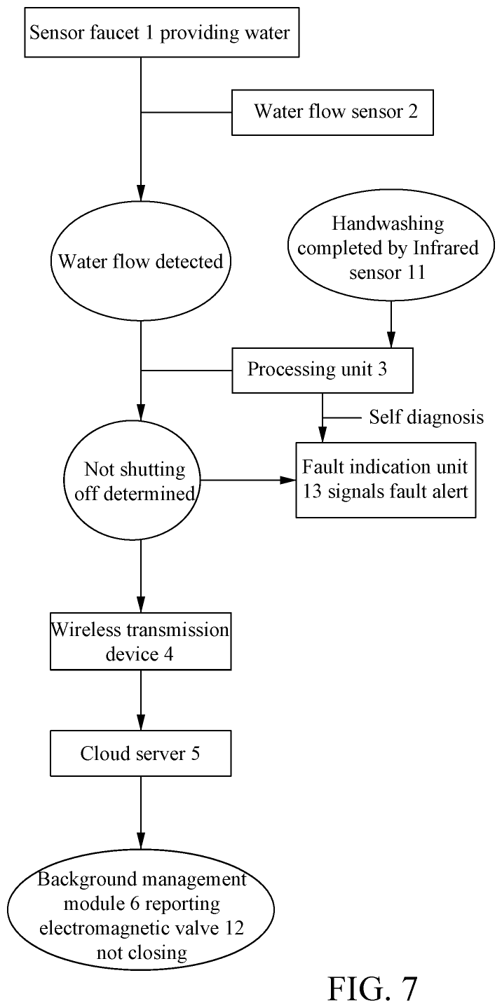

7. As shown in FIG. 7, when the infrared sensor 11 of the sensor faucet 1 detects that the user has completed handwashing, the processing unit 3 continuously measures the water flow rate and water flow duration based on the readings from the water flow rate sensor 2, and the electromagnetic valve 12 remains open in this case. In this scenario, the processing unit 3 determines that the sensor faucet 1 has a fault of not shutting off the water. The fault indication unit 13 displays a fault alert, and the wireless transmission device 4 uploads the fault message to the cloud server 5. The cloud server 5 sends the location of the faulty sensor faucet 1 and information regarding the issue of the electromagnetic valve 12 not closing to the background management module 6. To avoid potential misjudgments by the processing unit 3, a self-diagnostic process is implemented. When the situation depicted in FIG. 7 occurs, the processing unit 3 connects to the electromagnetic valve 12 of the sensor faucet 1 and generates a signal to close the electromagnetic valve 12. If multiple attempts to close the electromagnetic valve 12 result in the detection of continuous water flow, the processing unit 3 confirms that there is indeed a fault with the electromagnetic valve 12. It uploads the fault message to the background management module 6 to notify the management personnel for repairs.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A water supply system, comprising:
a sensor faucet comprising an infrared sensor, an electromagnetic valve for turning on or shutting off water supply, and a fault indication unit;
a water flow rate sensor configured between the electromagnetic valve and a water outlet of the sensor faucet to detect a water flow rate and a water flow duration of the sensor faucet; and
a processing unit electrically connected to the electromagnetic valve;
wherein data of the water flow rate and the water flow duration transmitted by the water flow rate sensor to the processing unit; the processing unit analyses the data; when the water flow rate is normal and the electromagnetic valve operates properly, the processing unit determines that the sensor faucet is functioning correctly; if the water flow rate does not meet a set value or the water flow duration exceeds a preset time, and the infrared sensor of the sensor faucet detects activity but no water is discharged, the processing unit determines that the sensor faucet is faulty; and, the processing unit generates a signal to the fault indication unit, which generates a fault alert for a management personnel.

2. The water supply system according to claim 1, wherein the water flow rate is determined based on number of times a wheel inside the water flow rate sensor is turned by water flowing through the water flow rate sensor.

3. The water supply system according to claim 1, further comprising a wireless transmission device connected to the processing unit; wherein, when the processing unit determines that the sensor faucet is faulty, in addition to generating a signal to the fault indication unit, the processing unit also generates a fault message to the management personnel through the wireless transmission device.

4. The water supply system according to claim 1, further comprising a cloud server and a background management module data-lined with the cloud server; wherein the wireless transmission device uploads the fault message to the cloud server; and the background management module displays information including a location of the faulty sensor faucet, an identification number of the faulty sensor faucet, and a cause to the faulty sensor faucet.

5. The water supply system according to claim 1, wherein, when the infrared sensor does not detect any user activity, but the processing unit detects water flow and measures the water flow duration based on the water flow rate sensor, and the electromagnetic valve is open, the processing unit determines that there is a leakage in the sensor faucet; the processing unit signals a fault alert through the fault indication unit; the wireless transmission device uploads the fault message to the cloud server; and the cloud server sends a location of the faulty sensor faucet and information regarding the leakage with the electromagnetic valve to the background management module.

6. The water supply system according to claim 5, wherein, to prevent potential misjudgment, the processing unit comprises a self-diagnostic process that the processing unit connects to the infrared sensor of the sensor faucet and reduces a sensing distance of the infrared sensor, and, when the infrared sensor reaches a minimum sensing distance, the processing unit confirms that there is indeed a fault with the electromagnetic valve.

7. The water supply system according to claim 1, wherein, when the infrared sensor of the sensor faucet detects user activity, but the processing unit does not detect any water flow or water flow duration based on the water flow rate sensor, and the electromagnetic valve is not open, the processing unit determines that there is a malfunction in the sensor faucet causing no water flow; the processing unit signals a fault alert through the fault indication unit; the wireless transmission device uploads the fault message to the cloud server; and the cloud server sends a location of the faulty sensor faucet and information regarding the electromagnetic valve not producing water flow to the background management module.

8. The water supply system according to claim 7, wherein, to prevent potential misjudgment, the processing unit comprises a self-diagnostic process that the processing unit connects to the electromagnetic valve of the sensor faucet and generates a signal to open the electromagnetic valve, and, if multiple attempts to open the electromagnetic valve result in no water flow detected, the processing unit confirms that there is indeed a fault with the electromagnetic valve and uploads the fault message to the cloud server and the background management module.

9. The water supply system according to claim 1, wherein, when the infrared sensor of the sensor faucet detects that the user has completed handwashing, the processing unit continuously measures the water flow rate and water flow duration based on the water flow rate sensor, and the electromagnetic valve remains open, the processing unit determines that the sensor faucet has a fault of not shutting off the water; the fault indication unit displays a fault alert; the wireless transmission device uploads the fault message to the cloud server; the cloud server sends a location of the faulty sensor faucet and information regarding the electromagnetic valve not closing to the background management module.

10. The water supply system according to claim 9, wherein, to prevent potential misjudgment, the processing unit comprises a self-diagnostic process that the processing unit connects to the electromagnetic valve of the sensor faucet and generates a signal to close the electromagnetic valve, and, if multiple attempts to close the electromagnetic valve result in a detection of continuous water flow, the processing unit confirms that there is indeed a fault with the electromagnetic valve and uploads the fault message to the cloud server and the background management module to notify the management personnel for repairs.
